(19) United States
(12) Patent Application Publication
(10) Pub. No.: US 2006/0164091 A1
(43) Pub. Date: Jul. 27, 2006

(54) Rotating magnet-induced current pipeline inspection tool and method

(75) Inventors: J. Bruce Nestleroth, Westerville, OH (US); Richard J. Davis, Columbus, OH (US)

Correspondence Address: BATTELLE MEMORIAL INSTITUTE, 505 KING AVENUE, COLUMBUS, OH, 43201-2693, US

(73) Assignee: Battelle Memorial Institute, Columbus, OH (US)

(21) Appl. No.: 11/129,087

(22) Filed: May 13, 2005

Related U.S. Application Data
(60) Provisional application No. 60/647,123, filed on Jan. 26, 2005.

(51) Int. Cl. G01N 27/72

(52) U.S. Cl. 324/326

(57) ABSTRACT

Disclosed are an apparatus and method for integrity monitoring of tubular components and, in particular, pipe walls. The apparatus comprises a configuration of permanent magnets arranged to rotate circumferentially within the pipe, whereby uniform low-frequency currents are generated within the pipe wall which, in turn, generate fields detectable with, for example, conventional Hall Effect sensors. The method comprises steps to rotate the apparatus within the pipeline and sense disruptions caused by anomalies in the pipe wall.

### CROSS-REFERENCE TO RELATED APPLICATION(S)

This application claims priority to U.S. Provisional App. Ser. No. 60/647,123, filed Jan. 26, 2005, the contents of which, to the extent not inconsistent herewith, are hereby incorporated by reference as if fully rewritten herein

### STATEMENT REGARDING FEDERALLY-SPONSORED RESEARCH OF DEVELOPMENT

This invention was made with Government support under Agreement No. DE-FC26-03NT41881 awarded by the Department of Energy, NETL. The Government may have certain rights to this invention.

### INCORPORATION-BY-REFERENCE OF MATERIAL SUBMITTED ON A COMPACT DISC

Not applicable.

### BACKGROUND OF THE INVENTION

1. Field of the Invention

This invention relates generally to apparatus designed and operated to inspect conductive objects, including electrically-conductive and magnetically-permeable objects, pipeline, heat exchanger tubing, and well casing walls for example, for corrosion and mechanical damage as well as other anomalies and defects such as cracks and pitting. More particularly, this invention relates to pipeline inspection apparatus which “crawl” inside the pipe independent of fluid flow within the pipe which employ rotating permanent magnets to generate uniform low-frequency electric currents within the walls which, in turn, generate magnetic fields detectable with conventional Hall Effect sensors.

2. Description of Related Art

Essential liquids and gases, including water, chemicals, and fossil fuels, flow through pipeline systems. Large volumes of products as diverse as petroleum and liquid hydrocarbons, natural gas, propane, and slurries of solids such as granulated coal and minerals such as copper and iron are constantly being transported between production sites and processing and consumption sites over long distances. These pipelines range generally between a few inches and 60 inches in diameter and extend to thousands of miles in length. Usually constructed of metal, in particular, ferrous metals, pipelines are susceptible to damage and other defects which affect the integrity of the system. The result can be a failure which threatens life and property, serious environmental damage, disruptions to both local and distant economies, and loss of the product being transported. The further result can be reduced public confidence in this efficient and economic means of transporting materials with possible public opposition to the growth of such means.

To minimize the risk of failure, pipelines are closely monitored and inspected. Inspection methods generally involve injecting a uniform energy into an object whereby an anomaly or defect disrupts this uniformity. Sensors then detect changes in the uniformity and, thus, the anomaly or defect. These methods utilize pipeline inspection apparatus which are inserted into the pipeline and move through the pipeline generally, but not exclusively, via the flowing material in the pipeline. In radiography, for example, anomalies are detected when a portion of the incident X-ray energy passes thru the material. A film or charge-coupled device placed on the opposite side of the material from the source can be used to detect this change in absorption. A pipeline inspection apparatus may also comprise magnetic components to induce magnetic flux within the pipeline wall. The magnetic flux naturally enters the metal wall of the pipeline and distributes evenly to produce a full volumetric inspection. Anomalies or defects in the wall of the pipeline tend to disrupt the uniform flow of the flux and create a leakage of magnetic flux which can then be detected by sensors, generally within the apparatus itself. This inspection methodology is known as magnetic flux leakage (“MFL”). MFL, however, can be difficult to implement on autonomous crawler systems because the apparatus are large and heavy. In addition, MFL-based apparatus are not able to detect all defect types and have nearly the same form factor as the pipe, making passage of diameter restrictions difficult. Among alternative approaches, small and lightweight apparatus have shown promise but implementation attempts have been thwarted by high speed and long distance requirements, factors that are not as restrictive for crawler-based inspection systems.

Other inspection methods include, for example, inducing electric currents in the pipeline via the placement of an auxiliary magnetic pole and relative movement of the inspection apparatus and the pipeline wall. See, e.g., U.S. Pat. No. 5,751,144 to Weischedel (“Weischedel”). Such methods generate circumferential currents that are best employed when attempting to detect axial cracks. As described in Weischedel, one of the “necessary conditions” for reliable detection is the induction of “substantial eddy currents so that eddy current changes representative of structural faults can be readily detected.” To properly induce such eddy currents, the inspection apparatus must first include a small, relative to the two main poles, “auxiliary pole” which “has the same magnetic poling as one of the primary poles” and the apparatus must be moving at a rate in excess of, generally, about four miles per hour relative to the pipeline wall to generate measurable and reliable eddy current signals. Thus, these methods rely upon the linear motion of the magnets through the inside of the pipe. In addition, the eddy currents and resultant signals are still generally weak and thus require more sophisticated sensors to detect anomalies.

Methods which utilize the remote field technique (RFT) or the remote field eddy current (RFEC) technique are also known. This technique uses a sinusoidal current flowing in an exciter coil (e.g., electric coils) to induce current in the pipe wall and a remote receiver coil over two pipe diameters away to detect defects such as metal loss and stress corrosion cracks. The resulting signals, however, are very small which necessitates expensive, sensitive lock-in amplifiers to detect such signals. These traditional RFEC techniques also use low-frequency exciters, but the sensitivity of the coil sensors used to detect signals from anomalies decreases with decreasing frequency. In addition, such techniques employ “indirect energy coupling” by sending the field outside the bounds of the pipe wall. See, e.g., U.S. Pat. No. 2,573,799 to MacLean. The use of electric motor concepts (though still coils) has also been developed. See, e.g., Plamen Alexandrov Ivanov, Remote Field Eddy Current Probes for the Detection of Stress Corrosion Cracks In Transmission Pipelines (2002) (unpublished Ph.D. dissertation, Iowa State University). Further discussions of RFEC may be found in T. R. Schmidt, History of the Remote-Field Eddy Current Inspection Technique, 47 Materials Evaluation 14 (1989).

### BRIEF SUMMARY OF THE INVENTION

Recent development efforts in the field of internal inspection of pipelines include a new generation of powered inspection platforms that “crawl” slowly inside a pipeline and are capable of maneuvering past physical barriers that can limit inspection. The present invention provides an electromagnetic inspection system for pipeline crawlers which can be used to assess a wide range of pipeline anomalies including corrosion, mechanical damage, and cracks. A rotating permanent magnet-based exciter assembly produces strong, uniform, low-frequency electric currents in the pipe wall. These currents spread in the wall away from the magnets and generate magnetic fields inside and outside the wall. At distances of generally one pipe diameter or more, the currents flow circumferentially and the current and the resulting magnetic fields are deflected by pipeline defects such as corrosion and axially-aligned cracks. Conventional Hall Effect sensors are used to detect these changes.

In one embodiment, a device is provided for detecting an anomaly in an electrically-conductive cylindrical structure, the device comprising a first and a second pole, the poles having opposite polarities, means for rotating the poles about an axis of rotation, the axis of rotation being coaxial with a long axis of the structure, whereby currents are induced within the structure, and at least one current flow sensor, the current flow sensor spaced apart from the first and second magnetic poles along the axis of rotation.

The device of the invention may also include spacing the sensor from the magnetic poles according to the relationship expressed in Eq. 1, below. The sensor of the invention may also include sensors adapted to sense axial magnetic flow and radial magnetic flow. In a preferred embodiment of the invention, the sensor is placed outside a near field and within a far field. In a further preferred embodiment, the first magnetic pole and the second magnetic pole each comprise a strength of greater than or equal to 25 megaGauss-Oersted.

The device of the invention may also include a magnetically-permeable bar to which the first and second poles are attached. In a further embodiment, the bar is adapted to include means to allow the bar to telescope along its long axis, thereby enabling the bar to ride over obstructions on the inside wall of the structure. Alternatively, or in combination, the bar may be hinged to provide the same capability.

In a method for detecting an anomaly in an electrically-conductive wall of a tubular structure such as a pipeline, the device of the invention may be placed within the structure and the bar rotated about its axis of rotation at about 1-10 Hz. The device is then urged through the structure. The induced currents, which themselves induce magnetic fields, are sensed by, for example Hall Effect sensors.

### BRIEF DESCRIPTION OF THE SEVERAL VIEWS OF THE DRAWINGS

FIG. 1 is an isometric view of an embodiment according to the present invention and illustrating the lines of induced current.

FIG. 2 is an isometric view of another embodiment according to the present invention.

FIG. 3a is a graphical representation of the signals coaxially near the rotating magnets according to the present invention.

FIG. 3b is a graphical representation of the signals coaxially far from the rotating magnets according to the present invention.

FIG. 4 is a graphical representation of the axial decay of the induced magnetic field flowing in the pipe wall according to the present invention.

FIG. 5 is a graphical representation of the decay for three magnetizer configurations according to the present invention.

FIG. 6 is a graphical representation of a typical sensor output signal from an anomaly according to the present invention.

FIGS. 7a-7d are graphical representations of the signals at the inside surface of the pipe wall at varying coaxial distances according to the present invention.

FIGS. 8a-8d are graphical representations of the signals at the inside surface of the pipe wall at varying coaxial distances according to the present invention.

FIG. 9 is a graphical representation of the signals from a corrosion anomaly 77 percent deep and two inches long according to the present invention.

FIG. 10 is a graphical representation of the signals from a corrosion anomaly 72 percent deep and 1.4 inches long according to the present invention.

FIG. 11 are elevation views of a telescopic structure according to the present invention.

FIG. 12 are elevation views of a hinge structure according to the present invention.

### DETAILED DESCRIPTION OF THE INVENTION

Reference Numerals

10 inspection apparatus
11 inspection apparatus
20 magnet assembly
22 magnet
24 magnet
26 clamp
28 bar
30 rotation arrow
35 drive mechanism
40 connector joint
42 alignment plate
44 alignment wheel
50 shaft
60 sensor array
62 sensor
70 pipe, cylinder, or other tubular structure
80 lines of current
90 telescoping mechanism
92 hinge mechanism

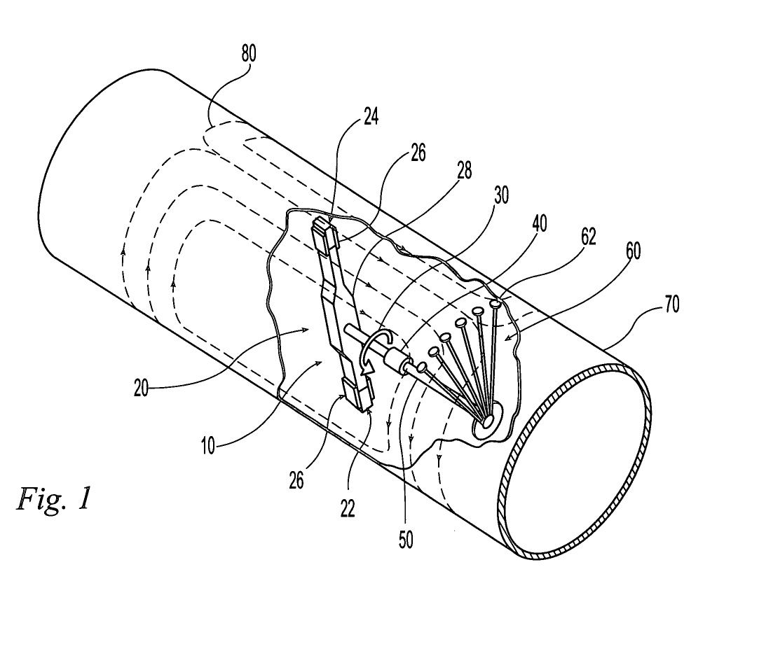

Beginning with FIG. 1, in an embodiment of the present invention 10, rotating (shown as rotation arrow 30) permanent magnets 22, 24 produce an alternating electrical current 80 flowing in a generally elliptical pattern. (As disclosed more completely below, a plurality of magnet pairs 22, 24 may be employed to produce the electrical current 80.) FIG. 1 shows the in-pipe positioning of a rotating permanent magnet exciter assembly 20 to induce strong currents 80 in the pipe wall 70. This approach uses alternating N and S poles 22, 24 rotating around a shaft 50. In a preferred embodiment, the magnets 22, 24 are magnetically connected with a magnetically-permeable bar 28 and are attached to the bar 28 with clamps 26 to form a magnet assembly 20. Since the pipe 70 is conductive and the magnets 22, 24 are moving, current 80 is generated in the pipe wall 70. The direction of the current is orthogonal to the direction of magnetization and the direction of motion. Since the direction of motion is circumferential 30 and the direction of the magnetization is radial, initially the flow of current is in the axial direction. The Law of Charge Conservation, however, states that there is no buildup of charge. Therefore, the current flows in loops 80, not segments. The basic flow of these loops 80 is illustrated in FIG. 1. The number of magnet pole pairs 22, 24 is an important variable along with the diameter of the pipe 70, its electrical conductivity, and its magnetic permeability.

Operably connected to the shaft 50 is a sensor array 60, preferably comprising Hall Effect sensors 62. The shaft 50 preferably comprises a connector joint means 40, widely known in the art, which allows the magnet assembly 20 to rotate 30 while enabling the sensor array 60 to remain rotationally stationary. In addition, the connector joint means 40 is preferably adapted to provide universal joint-like articulation between the sensor array 60 and the magnet assembly 20.

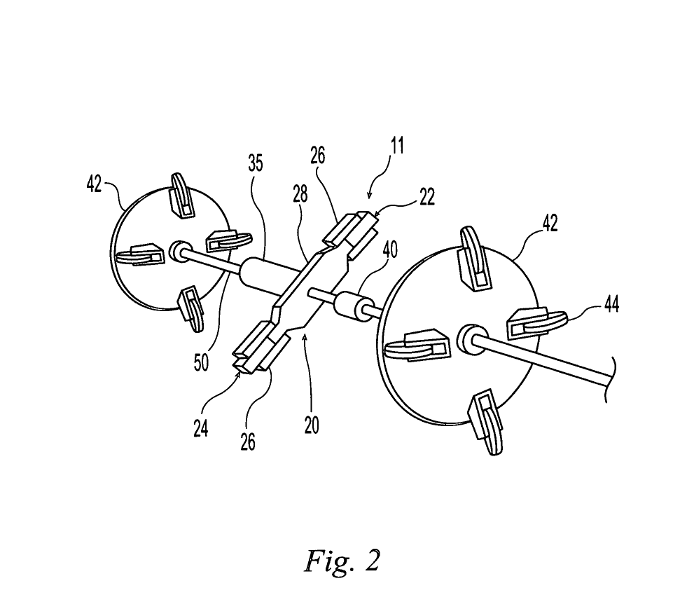

Shown in FIG. 2 is another embodiment of the invention. In addition to the magnet assembly 20, the shaft 50, and the connector joint 40, the inspection apparatus 11 comprises a drive mechanism 35 for rotating the magnet assembly 20 and a plurality of alignment plates 42 and alignment wheels 44 for aligning the apparatus 11 within the pipe 70. There are many choices for the drive mechanism 35. Applicants have found, for example, that a DC motor works well. For pipelines with high flow rates, a pneumatic drive could be used. The inspection apparatus 11 could also be inserted and positioned using directional drilling equipment with the rod supplying the needed rotational power.

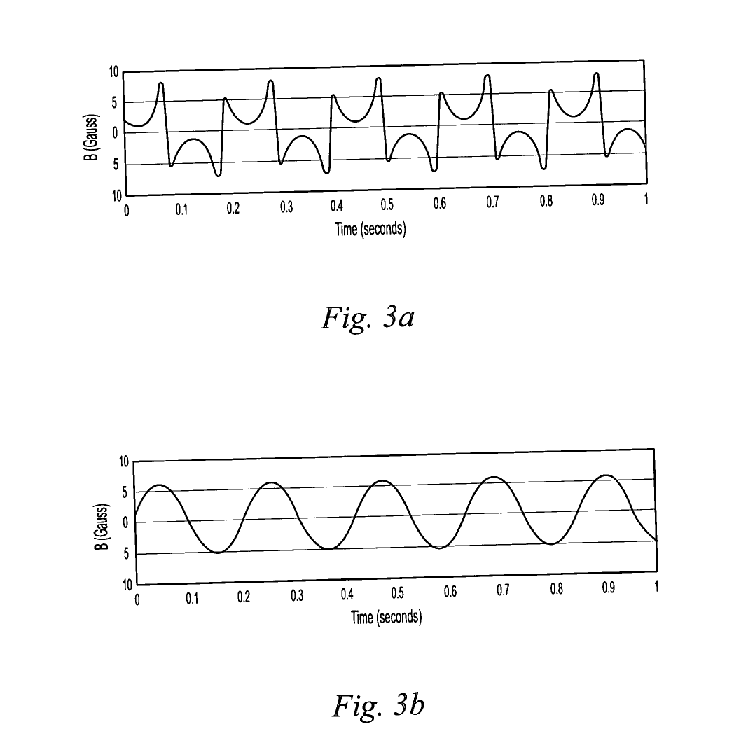

Turning now to FIGS. 3a and 3b, the magnetic field in the pipe has two general parts, each with distinct properties and effects. One part is the direct magnetic field from the strong permanent magnets 22, 24. The second field is due to the current 80 flowing in the pipe 70. FIGS. 3a and 3b are illustrative of the results of a magnet assembly 20 comprising two magnets 22, 24 rotating at five Hz in a 12-inch I.D. electric resistance welded (ERW) pipe 70 with a wall thickness of 0.358 inches. The magnet assembly 20 comprised two poles 22, 24 with 35 megaGauss-Oersted NdFeB permanent magnets. The dimension of the magnets 22, 24 were two inches in the axial direction, one inch in the circumferential direction, and one-half inch thick in the radial direction. The air gap was nominally one-third inch. Near (e.g., one-sixth pipe diameter) the rotating magnet assembly 20, the direct field from the magnets 22, 24 is dominant (near field) and produces a saddle-shaped alternating signal (FIG. 3a). Farther away (e.g., one pipe diameter) from the magnet assembly 20, magnetic fields caused by the currents 80 flowing in the pipe 70 dominate (far field) (FIG. 3b). The current 80 in the pipe 70 induces a magnetic field which can be detected by a coil or a Hall Effect sensor 62/sensor array 60. Thus, placement of the sensor array 60 is important. In this example, when the separation of the sensor array 60 and the magnet assembly 20 is about one pipe diameter away, the direct fields from the magnetizer are negligible. Also, the current 80 in the pipe 70 is nominally sinusoidal. The separation distance required to achieve a sinusoidal signal is dependent on both the diameter of the pipe 70 and the number of N-S magnet pairs 22, 24.

Turning now to Eq. 1, below, the amplitude of the magnetic field (Bₚₖ) produced by the current 80 decreases as the coaxial separation distance (z) between the magnet assembly 20 and the sensor array 60 increases. To a first order approximation, the rate of decay is nominally exponential and proportional to the ratio of the number (n) of N-S magnet pairs 22, 24 divided by the radius (r) of the cylinder 70.

$${B}_{p k} ( z ) ∝ \frac{β}{n} {( \frac{r}{δ} )}^{2} {M}_{0} {ⅇ}^{- ( \frac{n}{r} ) Z} , where \\ r = Radius of Cylinder \\ {δ}^{2} = 2 / ω σ μ ( classical skin depth ) \\ n = Number of Pole Pairs \\ β = Coupling Factor \\ ω = Rotational Frequency \\ σ = Conductivity \\ μ = Magnetic Permeability \\ {M}_{0} = Magnetizing Strength of Magnetizer Piece \\ Z = length along axis of rotation . \qquad Eq . 1$$

Eq. 1 implies that the current 80 in the cylinder 70 decays faster for smaller diameter cylinders 70 and magnet assemblies 20 with more poles 22, 24. The physical explanation is that few poles 22, 24 in large cylinders 70 enable the establishment of large current loops 80 that extend a significant distance from the magnet assembly 20. Conversely, many poles 22, 24 in small cylinders 70 produce many small loops 80 that oppose one another and do not extend far from the magnet assembly 20. The initial magnitude of the current 80 (at z=0) is proportional to many variables; the amplitude increases with increasing diameter, magnet strength, magnet coupling, conductivity, permeability, and rotational frequency and decreases with increasing number of pole pairs. From the examination of both the amplitude and decay terms, the signal is strongest for larger diameter tubes with few poles.

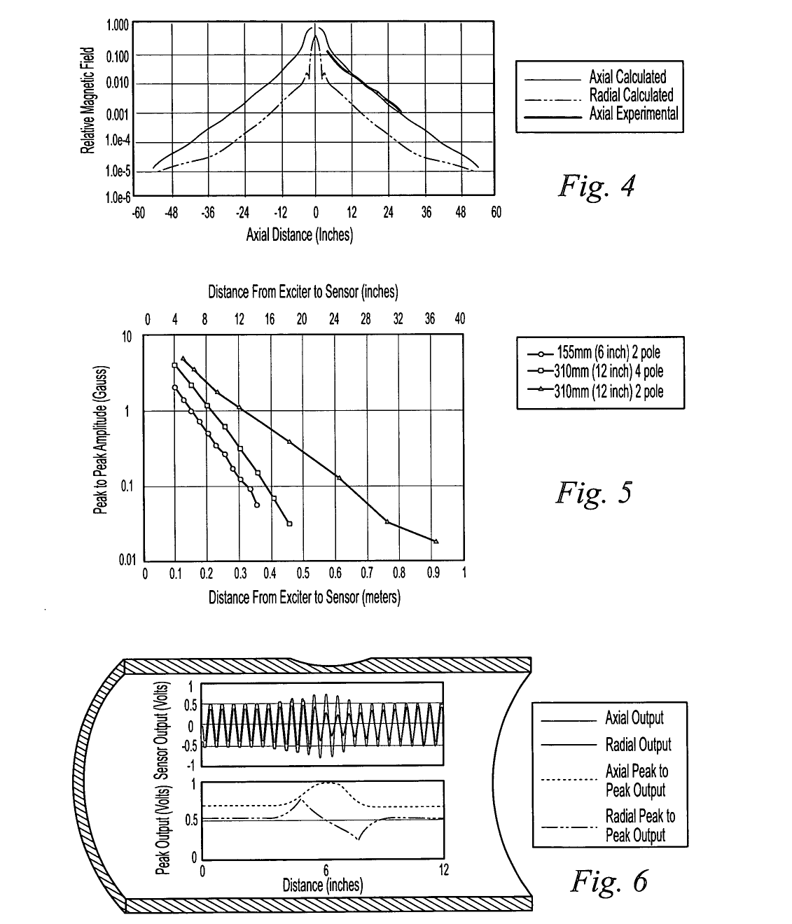

FIG. 4 shows graphically the computed axial decay of the axial component and the radial component compared with experimental results. The computed results were obtained using magnetic finite element analysis (FEA). The solution was obtained using a three-dimensional rotational analysis problem solver that could calculate the current generated by a permanent magnet passing a conductor. (Opera-3d® from Vector Fields, Ltd., Aurora, Ill.) For the experimental results, the rotating magnet assembly 20 was at one axial location while the sensor 62 was moved along the inside surface of the pipe 70. At discrete locations along the pipe, the amplitude was measured with a Hall Effect sensor 62. The density of measurements was greater in the near field than the far field due to the nature of the amplitude changes. As illustrated in FIG. 4, calculations and experiments show that the magnetic field decay is exponential. The rate of decay in the 12-inch pipe is nominally an order of magnitude per pipe diameter. Experimental verification is superimposed on the modeling results.

FIG. 5 shows how the decay rate is related to both pipe diameter and number of poles. Three configurations were tested: (1) a six-inch (155 mm) diameter pipe and two-pole magnetizer; (2) a 12-inch (310 mm) diameter pipe and two-pole magnetizer; and (3) a 12-inch (310 mm) diameter pipe and four-pole magnetizer. The wall thickness of both pipe samples was nominally 0.37 inches (9 mm) and it was assumed that the magnetic permeability and electrical conductivity of both samples were equal. The rotational frequency was five hertz. The rotation speed for the four-pole unit was cut in half to keep the frequency of the inspection current equal to the other two configurations. The plots of FIG. 5 show that the decay rate is similar for the six-inch magnetizer with two poles and the 12-inch magnetizer with four poles; only the initial amplitude of the smaller diameter magnetizer is lower. The decay rate of the 12-inch magnetizer with two poles is nominally half of the other two. For the four-pole configuration in the 12-inch pipe, two bars 28 were added to the two-pole magnet assembly 20 and the polarity of the magnets assigned appropriately.

A typical test result from an anomaly is shown in FIG. 6. A prototype system was pulled through a 12-inch diameter, nominally 0.37-inch thick pipe with machined metal loss defects. Data from both an axial and a radial Hall Effect sensor were recorded continuously as the tool was pulled smoothly through the pipe without stopping. The Hall Effect sensors were of the widely-available commercial linear ratiometric type. The field levels were amplified by a factor of 100 using an operation amplifier after the Q-point offset was removed using a resistance voltage divider. A 1000-ohm ten-turn potentiometer was used to adjust for the variation between sensors. The two sensors were collocated for the measurement of the axial and radial component of the magnetic field. The axial speed of the tool was nominally three inches per second. The rotation of the magnets was 300 rpm (5 Hz). The upper graph shows the unprocessed sinusoidal signals. The lower graph shows a tracing through the peak values. The axial component of the magnetic field increases at the metal loss area. The radial component increases before the metal loss area and then decreases after. While typical variations in conductivity and permeability of the pipe can affect amplitude, by detecting both the axial and radial signal one can simplify detection.

A combination of modeling and prototyping was used to improve the inspection current strength propagating along the pipe 70 used to detect pipeline anomalies. After examining various configurations, the best performance was achieved using a two-pole exciter 20. A prototype for a 12-inch diameter pipeline is shown in FIG. 2. A pair of NdFeB magnets 22, 24, each two inches long, one inch wide, and 0.5 inches thick, and having a strength of 38 megaGauss-Oersted, is placed on a steel core 28. The core 28 was machined from 1018 steel. While the magnets 22, 24 have a strong attraction to the steel core 28, aluminum guide rails 26 position the magnets 22, 24 precisely on the core 28. The air gap between the magnet 22, 24 and the nominally 0.37-inch thick test pipe was 0.5 inches. Wheeled 44 support plates 42 kept the magnet assembly 20 centered in the pipe and a variable-speed direct current motor 36 was used to rotate the magnet assembly 20.

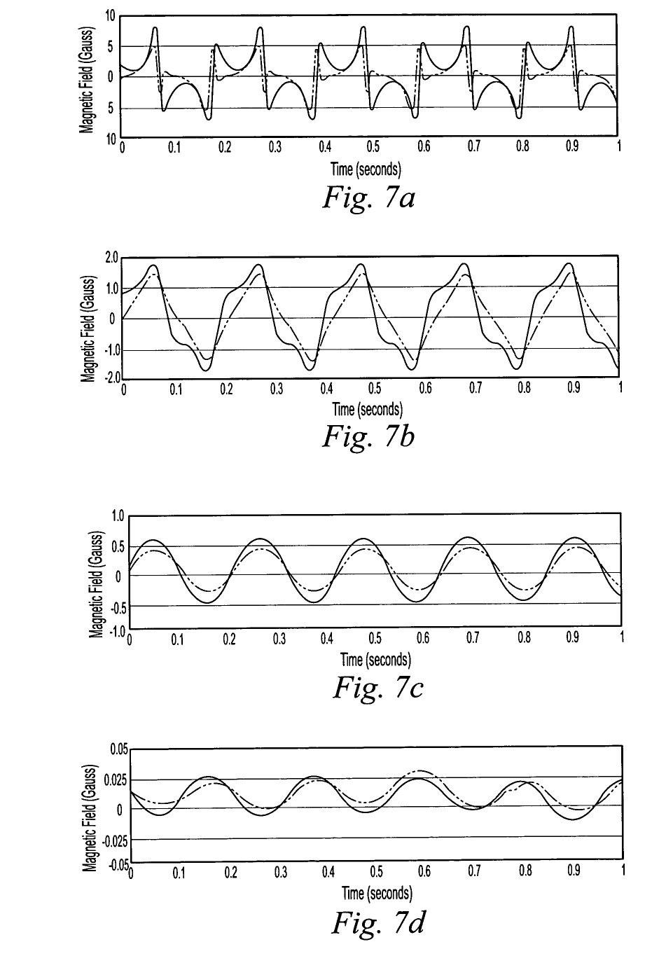

FIGS. 7a-7d illustrate the magnetic field at the inside surface of the pipe wall at distances ranging from close to the magnet array (one-sixth pipe diameter) to 2.5 pipe diameters for a two-pole system rotating at 5 Hz in a 12-inch diameter pipe. Indicated are the radial (solid lines) and axial (broken lines) signals. FIG. 7a is at one-sixth pipe diameter, FIG. 7b is at one-half, FIG. 7c is at one pipe diameter, and FIG. 7d is at 2.5 pipe diameters. As shown, the field due to direct field effects is negligible at distances greater than one pipe diameter and the measured signal is nearly sinusoidal. The field is also strong, being on the order of one Gauss. The currents are detectable at distances beyond two pipe diameters.

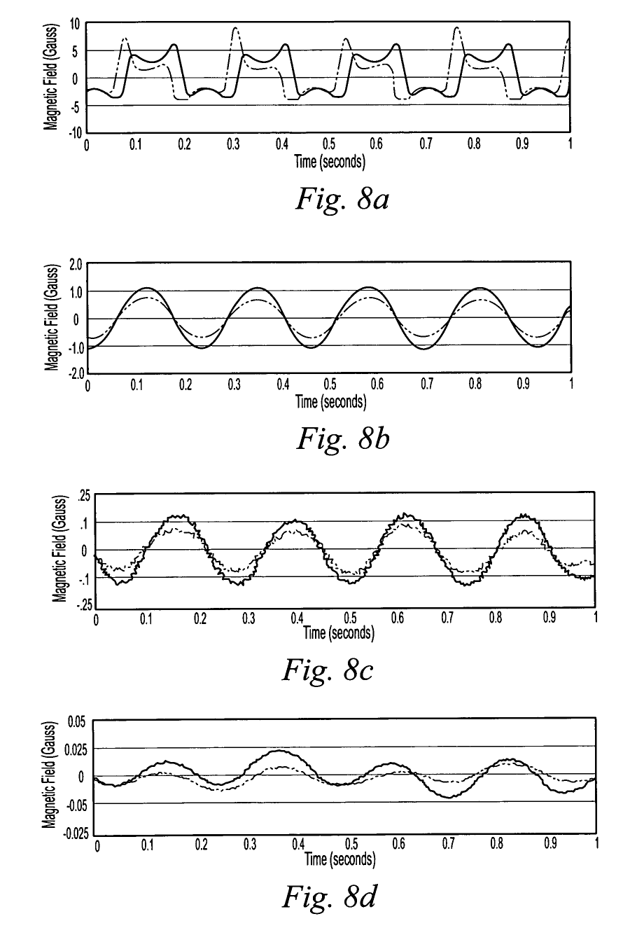

Similarly, FIGS. 8a-8d illustrate the magnetic field at the inside surface of the pipe wall at distances ranging from one-sixth pipe diameter (FIG. 8a), to one-half pipe diameter (FIG. 8b), to one pipe diameter (FIG. 8c), to 1.5 pipe diameters (FIG. 8d) for a four-pole system rotating at 2.5 Hz in a 12-inch diameter pipe. As indicated, the signal levels at similar distances are not as strong and contain more noise.

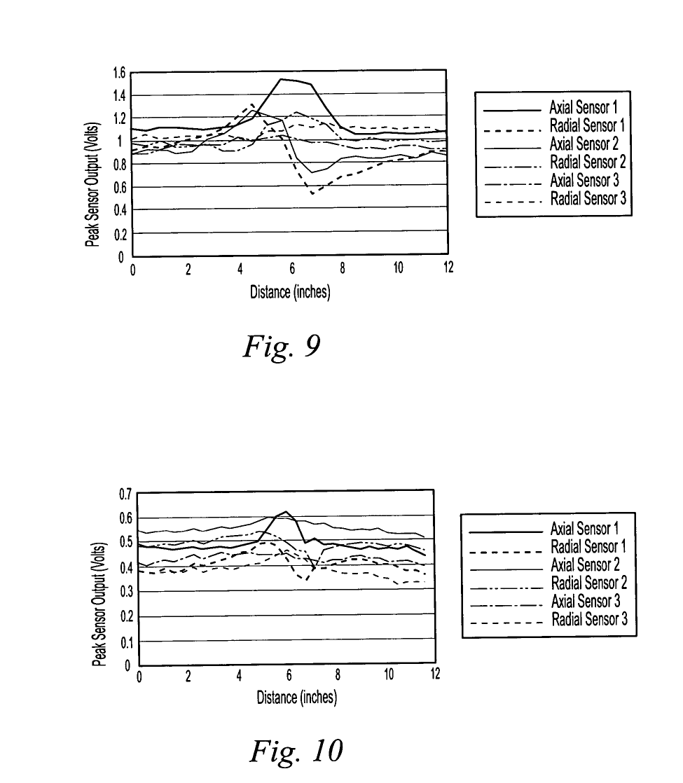

FIGS. 9 and 10 show the results of tests performed with the prototype described above for particular corrosion anomalies. FIG. 9 illustrates the signals for an anomaly 77 percent deep and two inches long (characterized as deep and long). FIG. 10 illustrates the signals for an anomaly 72 percent deep and 1.4 inches long (deep and long). In both cases, axial sensor 1 and radial sensor 1 were directly radially aligned with the anomaly, sensors 2 were offset by nominally five degrees, and sensors 3 were offset by nominally an additional five degrees in the same circumferential direction.

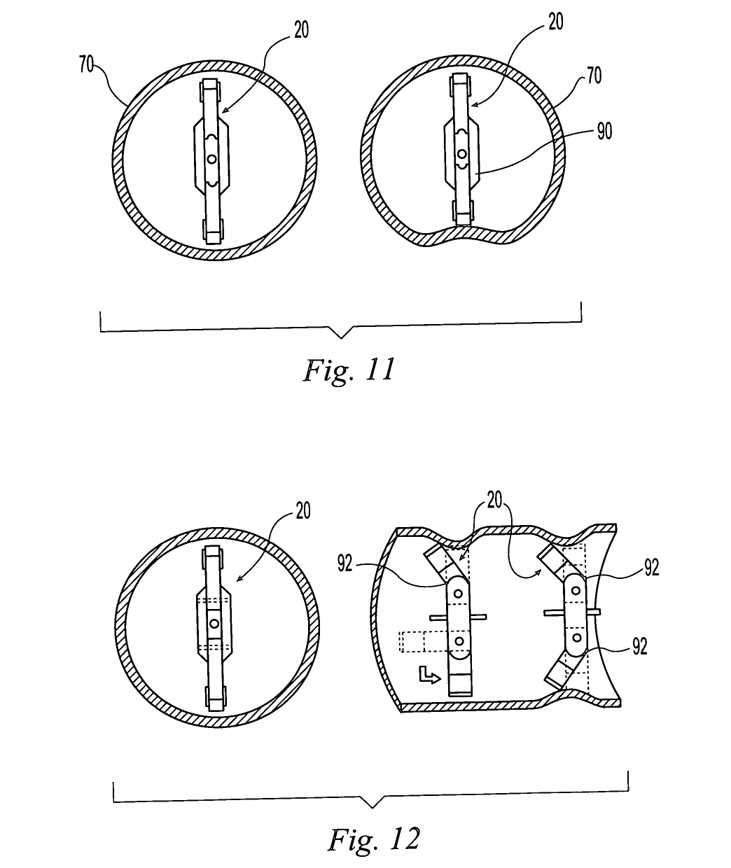

In another embodiment of the present invention, the magnet configuration comprises a form factor that enables the tool to pass obstructions within the pipeline. For example, FIG. 11 shows a telescopic structure 90 that enables the bars to which the magnets are attached to shorten as they pass over obstructions. Alternatively, FIG. 12 shows a hinged structure 92 that enables the bars to bend to pass over obstructions. Other collapsing arrangements, such as spring-loaded universal joints or combinations may also be employed. For the telescoping structure 90, simple mechanical devices such as worm screws can be used to move the magnets into the proper position for inspection. However, the maximum extent of the telescoping magnetizer 90 in the collapsed position is greater than the hinge configuration 92. For the hinge configuration 92, the magnetizer could be designed to fit through obstructions that are less than one-third the pipe diameter. In he collapsed position, however, the force of attraction of the magnets may be strong and the mechanism to return the magnets to the inspection position might require considerable force.

Following from the above description and invention summaries, it will be appreciated by those skilled in the art that, while the apparatus and methods described and illustrated herein constitute exemplary embodiments of the present invention, the invention is not limited to those precise embodiments and that changes and modifications may be made thereto without departing from the scope of the invention as defined by the claims. Likewise, it is to be understood that the invention is defined by the claims and it is not intended that any limitations or elements describing the exemplary embodiments set forth herein are to be incorporated into the claims unless explicitly recited in the claims themselves. Finally, it is to be understood that it is not necessary to meet any or all of the recited advantages or objects of the invention disclosed herein in order to fall within the scope of any claim, since the invention is defined by the claims and since inherent and/or unforeseen advantages of the present invention may exist even though they may not have been explicitly discussed herein.

We claim:

1. A device to aid in detecting an anomaly in an electrically-conductive wall of a pipeline, the device comprising:
a magnetically-permeable bar, the bar adapted to be positioned diametrically within the pipeline and comprising:
a first end, the first end comprising:
a first permanent magnet, the first permanent magnet comprising:
a first magnetic polarity; and
a magnetic strength of greater than or equal to 25 megaGauss-Oersted;
a second end, the second end comprising:
a second permanent magnet, the second permanent magnet comprising:
a second magnetic polarity; and
a magnetic strength of greater than or equal to 25 megaGauss-Oersted; and
an axis of rotation, the axis of rotation being equidistant from the first end and the second end and adapted to be coaxial with the long axis of the pipeline; and
means for rotating the bar about the axis of rotation, whereby currents are induced within the wall.

2. The device of claim 1, further comprising:
a sensor array, the array spaced from the bar along the axis of rotation.

3. The device of claim 2, wherein:
the sensor array comprises at least one Hall Effect sensor.

4. The device of claim 3, wherein:
the at least one Hall Effect sensor is adapted to sense axial magnetic flow.

5. The device of claim 3, wherein:
the at least one Hall Effect sensor is adapted to sense radial magnetic flow.

6. The device of claim 3, wherein:
the at least one Hall Effect sensor is adapted to sense circumferential magnetic flow.

7. The device of claim 2, wherein:
the array is outside a near field.

8. The device of claim 2, wherein:
the array is within a far field.

9. The device of claim 2, wherein:
the array is spaced from the bar by at least one-third the diameter of the pipeline.

10. The device of claim 2, wherein:
the array is spaced from the bar according to the relationship:
$${B}_{p k} ( z ) ∝ \frac{β}{n} {( \frac{r}{δ} )}^{2} {M}_{0} {ⅇ}^{- ( \frac{n}{r} ) Z} .$$

11. The device of claim 2, further comprising:
means for transmitting output from the array; and
means for recording the output from the array.

12. A method for detecting an anomaly in an electrically-conductive wall of a pipeline, the method comprising the steps of:
(a) positioning the device of claim 2 coaxially within the pipeline;
(b) rotating the bar, whereby far field currents are induced within the wall;
(c) urging the device through the pipeline; and
(d) sensing the current flow within the wall within a far field.

13. The method of claim 12, further comprising the step of:
(e) rotating the bar at a rate greater than or equal to one Hertz.

14. The method of claim 12, further comprising the steps of:
(e) transmitting an output from the array; and
(f) recording the output from the array.

15. A device for detecting an anomaly in an electrically-conductive cylindrical structure, the device comprising:
a first and a second magnetic pole, the first and second magnetic poles spaced apart and having opposite polarities;
means for rotating the first and second magnetic poles about an axis of rotation, the axis of rotation coaxial with a long axis of the structure, whereby currents are induced within the structure; and
at least one current flow sensor, the current flow sensor spaced from the first and second magnetic poles along the axis of rotation.

16. The device of claim 15, wherein:
the sensor is spaced a distance (z) from the first and second magnetic poles according to the relationship:
$${B}_{p k} ( z ) ∝ \frac{β}{n} {( \frac{r}{δ} )}^{2} {M}_{0} {ⅇ}^{- ( \frac{n}{r} ) Z} .$$

17. The device of claim 15, wherein:
the at least one sensor comprises:
a first sensor adapted to sense axial magnetic flow; and
a second sensor adapted to sense radial magnetic flow.

18. The device of claim 15, wherein:
the at least one sensor is outside a near field.

19. The device of claim 15, wherein:
the at least one sensor is within a far field.

20. The device of claim 15, wherein:
the at least one sensor is spaced apart at least one-third the diameter of the structure.

21. The device of claim 15, wherein:
at least one of the first magnetic pole and the second magnetic pole comprises a strength of greater than or equal to 25 megaGauss-Oersted.

22. The device of claim 15, wherein:
the structure is tubular.

23. The device of claim 22, wherein:
the first magnetic pole and the second magnetic pole are operably connected to a magnetically-permeable bar, the bar adapted to be positioned diametrically within the structure.

24. The device of claim 23, the bar further adapted to telescope along a long axis of the bar.

25. The device of claim 23, the bar further comprising:
at least one hinge, the hinge adapted to enable a portion of the bar to pivot about the hinge.

26. The device of claim 15, wherein the at least one sensor comprises a Hall Effect sensor.

27. The device of claim 23, further comprising:
a frame, the frame having a generally cylindrical shape and adapted to be positioned coaxially within the tubular structure, the bar being rotatably attached to the frame; and
means attached to the frame for rotating the bar circumferentially relative to the interior of the tubular structure.

28. A method for detecting anomalies in an electrically-conductive tubular structure, comprising the steps of:
(a) positioning the device of claim 27 within the tubular structure; and
(b) rotating the bar about the axis of rotation, whereby currents are induced within the tubular structure.

29. The method of claim 28, wherein the currents are substantially sinusoidal.

30. The method of claim 28, further comprising the step of:
(c) detecting current flow within the tubular structure.

31. The method of claim 30, further comprising the steps of:
(d) transmitting the results of the detecting step; and
(e) recording the results.

32. The method of claim 28, wherein the bar is rotated at a rate greater than or equal to one Hertz.
